(19) United States
(12) Patent Application Publication
(10) Pub. No.: US 2020/0339239 A1
(43) Pub. Date: Oct. 29, 2020

(54) HINGED BLIMP

(71) Applicant: Mothership Aeronautics Limited, San Mateo, CA (US)

(72) Inventors: Lawrence Fleming, Lake Elsinore, CA (US); Jonathan Leopold Nutzati Fontaine, South San Francisco, CA (US)

(73) Assignee: Mothership Aeronautics Limited, San Mateo, CA (US)

(21) Appl. No.: 16/761,170

(22) PCT Filed: Nov. 1, 2018
(86) PCT No.: PCT/US2018/058805

§ 371 Date: May 1, 2020

Related U.S. Application Data
(60) Provisional application No. 62/580,404, filed on Nov. 1, 2017.

(51) Int. Cl. B64B 1/18; B64B 1/30; B64C 39/02

(52) U.S. Cl. CPC B64B 1/18; B64B 1/30; B64C 2201/101; B64C 2201/022; B64C 39/024

(57) ABSTRACT

A hinged blimp system is disclosed. A hinged blimp system includes a vectored thrust engine, which may or may not be implemented as part of a remotely piloted airship vehicle (RPAV) subsystem that is coupled to a ground-based subsystem. The vectored thrust engine includes a vectored thrust frame coupled to a support structure that is, in turn operationally connected to a balloon envelope. The vectored thrust frame is coupled to the support structure via a hinge, or knuckle, with a pitch axle and a roll axle.

### BRIEF DESCRIPTION OF THE DRAWINGS

FIG. 1A is a diagram of a side view of an example of a hinged blimp system.

FIG. 1B is a diagram of a bottom view of the interface section of the example of a hinged blimp system of FIG. 1A.

FIG. 1C is a diagram of a top view of the propulsion module section of the example of a hinged blimp system of FIG. 1A.

FIG. 1D depicts a diagram of a perspective view of a thrust vector joint of the example of a hinged blimp system of FIG. 1A.

FIG. 2 is a diagram of top views of alternative propulsion module sections for a hinged blimp system.

FIG. 3 is a diagram of a perspective view of an alternative thrust vector joint of a hinged blimp system.

FIG. 4 depicts a diagram of an example of an electrical connection of electrical components in a hinged blimp system.

FIG. 5 depicts a flowchart of an example of a method for carrying out a flight operation of a hinged blimp system.

FIG. 6 illustrates configurations of the propulsion module section of the hinged blimp system of FIG. 1A in operation.

FIG. 7 depicts an experimentation result obtained by flight of an example of a hinged blimp system.

FIGS. 8A, 8B, and 8C illustrate views of a hinged blimp with alternative structures.

FIG. 9. Illustrates views of a vector thrust unit (VTU) top view and VTU internal top view.

FIGS. 10A and 10B illustrate different views of the top internal view of a VTU structure.

FIG. 11 depicts a conceptual diagram of a centrally mounted VTU structure in a T configuration where one of a pitch axle and a roll axle is terminated at the intersection of the pitch and roll axles.

### DETAILED DESCRIPTION

A prototype hinged blimp system is capable of very high endurance flight. A 90-minute flight demonstration was performed with the prototype hinged blimp, which included a variety of flight maneuvers without the battery dropping below 95%. The batteries used in the application were 8000 mAh 3 cell lithium polymer (Li—Po) batteries. The prototype hinged blimp was based on a production blimp design, the e700b600 blimp, designed, fabricated and sold by Microflight Inc. It consists of a 7 m long polyurethane envelope with a carbon-fiber gondola mounted below the centroid and 4 servo-actuated control surfaces at the stern. The control surfaces are made of carbon-fiber reinforced Depron foam and consist of vertical stabilizers above and below the tail with rudders for yaw control and two horizontal control surfaces left and right of the tail with elevators for pitch control. The lower vertical stabilizer has a yaw motor mounted into it for additional yaw control at low airspeed flight conditions. The gondola, which is optional, includes a carbon-fiber shell in which are mounted a pair of thrusters mounted on a winch-driven axel for pitch axis vectoring, the 2 Li—Po batteries and the RC receiver. The prototype hinged blimp was operated up to 500 g heavier than air for safety purposes. For the prototype hinged blimp, the weight is achieved by the addition of ballast, in the absence of which the hinged blimp is nominally neutrally buoyant.

The prototype hinged blimp includes a cylindrical envelope section added at the center for ease of solar panel mounting, and additional wiring and voltage regulation circuitry to allow the solar panels to both charge the batteries and directly power the thrusters. Once the solar-powered prototype hinged blimp passed validation, the next development was to attach a photogrammetry payload and to perform basic photogrammetry missions. One goal, in a specific vertical, was for the hinged blimp was to perform aerial inspections on long linear infrastructure, which requires hitting a series of consecutive GPS waypoints with a consistent degree of precision, and taking photographs at those waypoints.

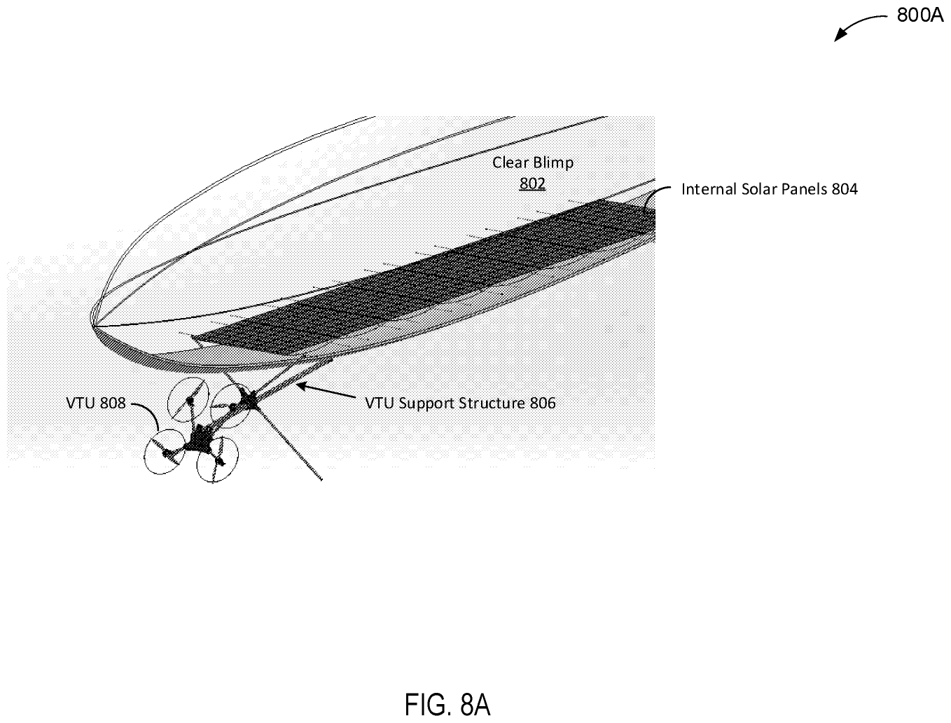

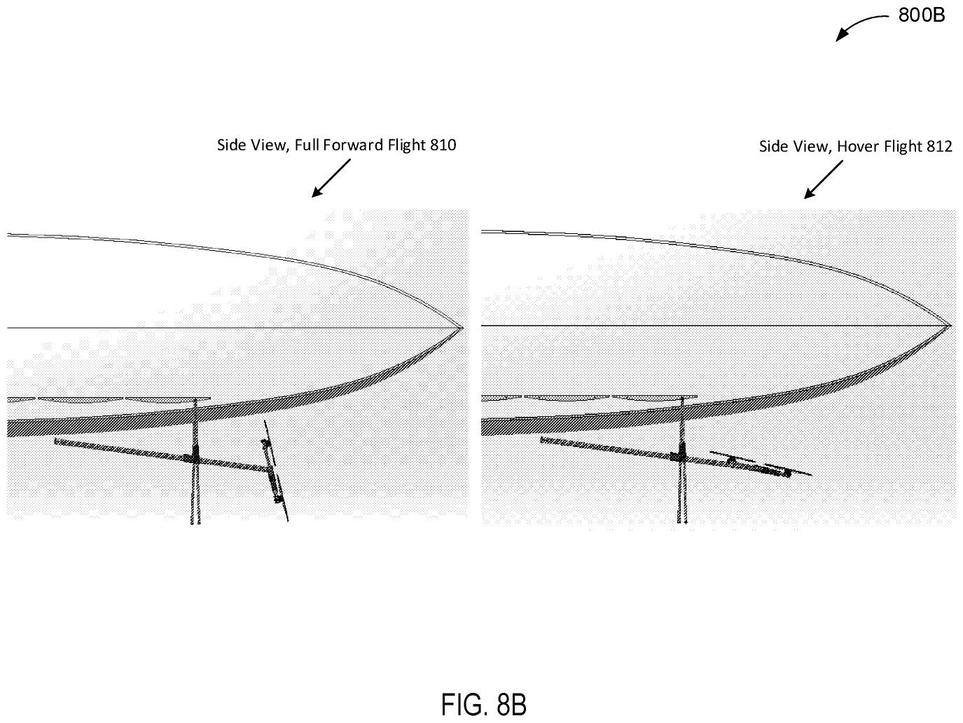

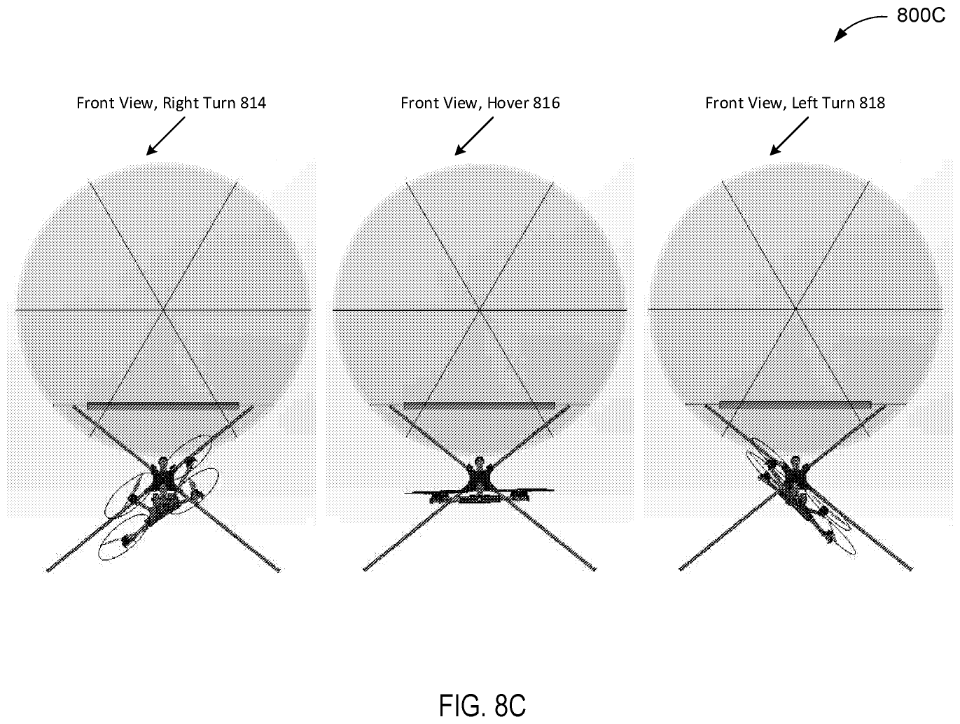

A solution was proposed that would decouple the weathervane effect of the blimp from its ability to maintain a specific position in space in various wind and gust conditions. The solution involved 3 steps: 1) the propulsion system mounted in an outboard configuration by 3 points to the nose of the hinged blimp envelope; 2) the propulsion system is an array of thrusters that are jointly vectored to provide, lift, thrust and directional control to the airship by pitching and rolling on its own axes; and 3) the propulsion system was configured with an autopilot and stabilization system. This solution proved very effective at controlling the hinged blimp in various wind conditions and allowed for a rapid path to automation. Advantageously, the hinged blimp was able to achieve the accuracy and repeatability needed to hit GPS waypoints under manual piloting. It may be noted that, as is most readily visible in the example of FIGS. 8, the propulsion system can be mounted in an outboard configuration by 2 points to the nose of the hinged blimp envelope.

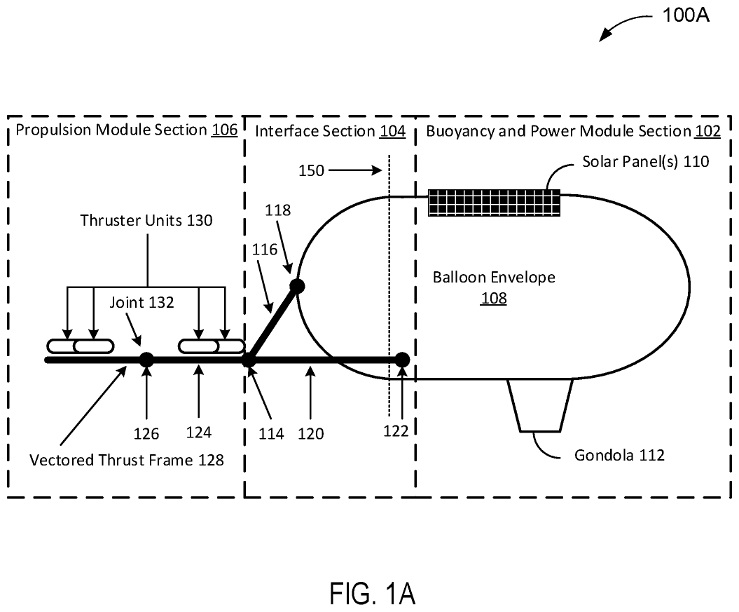

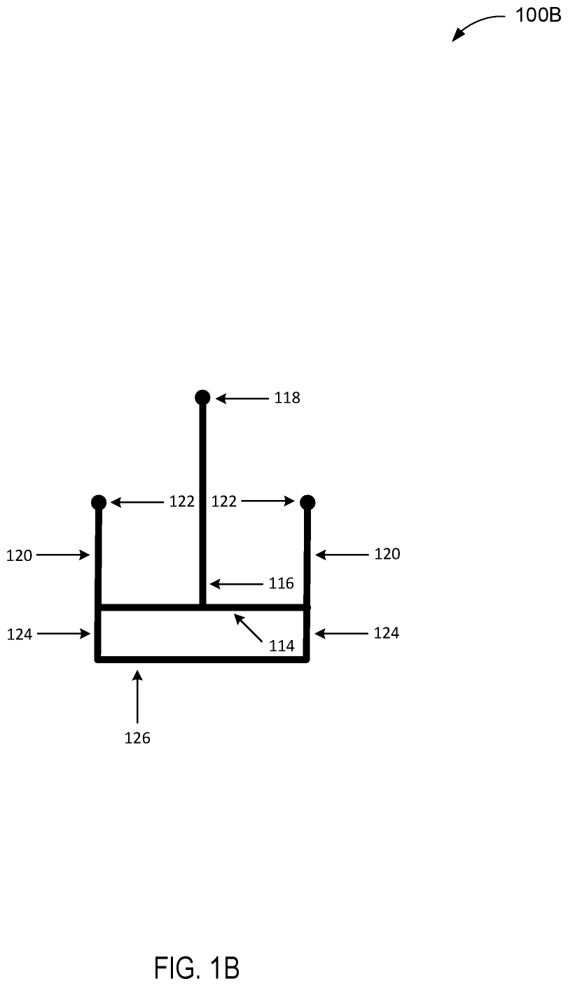

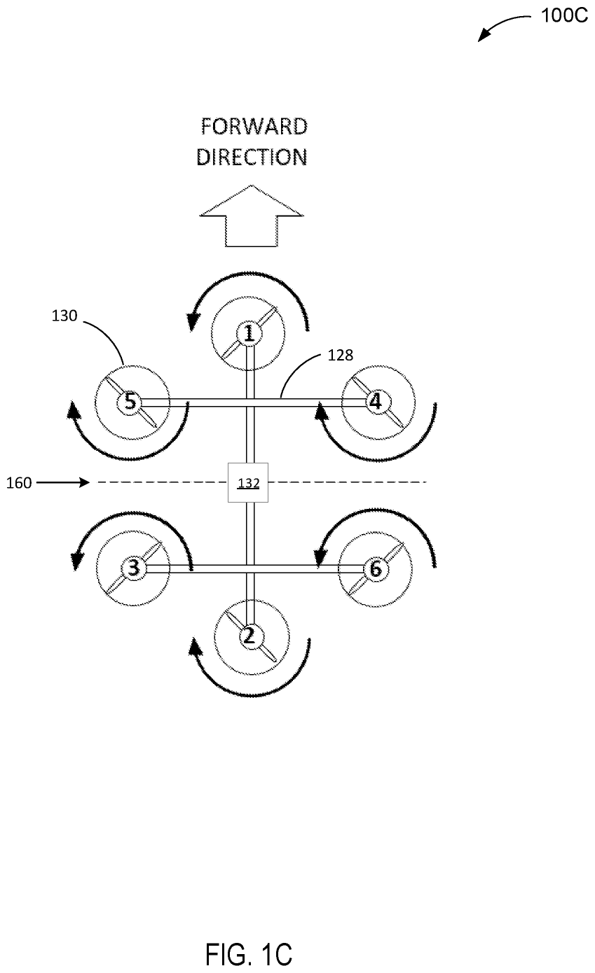

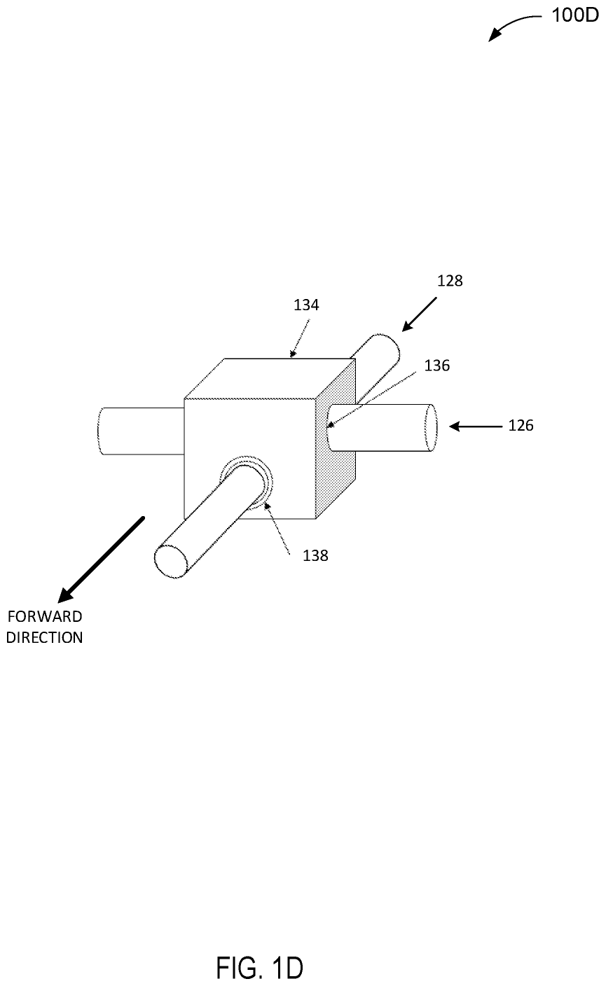

FIG. 1A depicts a diagram 100A of a side view of an example of a hinged blimp system conceptually not unlike the prototype hinged blimp described in the preceding paragraphs. FIG. 1B depicts a diagram 100B of a bottom view of an interface section of the example of a hinged blimp system of FIG. 1A. FIG. 1C depicts a diagram 100C of a top view of a propulsion module section of the example of a hinged blimp system of FIG. 1A. FIG. 1D depicts a diagram 100D of a perspective view of a thrust vector joint of the example of a hinged blimp system of FIG. 1A. (FIGS. 1A, 1B, 1C, and 1D may be referred to collectively hereinafter as FIG. 1.) In a specific implementation, a hinged blimp system, such as is illustrated in FIG. 1, may be operated up to 500 grams heavier than air for safety purposes. If the weight of the hinged blimp system without the ballast is insufficient, the weight of the hinged blimp system can be adjusted to a preferable weight by adding a ballast (not shown).

The hinged blimp system illustrated in FIG. 1 includes three functional sections, a buoyancy and power module section 102, an interface section 104, and a propulsion module section 106. The buoyancy and power module section 102 includes a balloon envelope 108, solar panel(s) 110, and an optional gondola 112. (The balloon envelope 108 appears to extend into the interface section 104 in the diagram 100A, but is not part of the interface section 104.) The balloon envelope 108 is intended to represent a container in which gas is introduced to provide buoyance to the hinged blimp system and other components (not shown) relevant to providing and maintaining buoyancy in the air. In a specific implementation, the gas introduced in the balloon envelop 108 is helium, but other lighter-than-ambient gases, included heated air, may be used for the purpose of providing buoyancy. In a specific implementation, the balloon envelope 108 is made of a synthetic polymer material such as polyurethane, but balloon envelopes can be made from a variety of materials, such as polyurethane, polyester, Dacron®, Mylar®, Tedlar® bonded with Hytrel®, or other generally weather-resistant plastic film, fabric, or combination thereof. In a specific implementation, the balloon envelope 108 is bladderless, but in an alternative the balloon envelope 108 includes a bladder made of a thin leak-resistance film, such as polyurethane. In a specific implementation, the balloon envelope 108 operates without ballonets, but in an alternative the hinged blimp system includes ballonets and air scoops that channel air to the ballonets. The balloon envelope 108 appears somewhat ovoid in the diagram 100A with a central portion that is substantially cylindrical, but appears circular in the diagram 100B. In a specific implementation, the balloon envelope 108 is about 7 meters long with a diameter of no more than about 1.3 meters.

The solar panel(s) 110 illustrated in FIG. 1 are intended to represent a portion of a photovoltaic subsystem designed to supply usable solar power to the hinged blimp system. The solar panel(s) 110 includes one or more solar panels that absorb and convert sunlight into electricity. The photovoltaic subsystem can also include a solar inverter to change the electric current from DC to AC, as well as mounting, cabling, and other accessories to set up a working system (not shown in the example of FIG. 1). The solar panel(s) 110 are depicted as attached to the top of the balloon envelope 108 in the diagram 100A, which is the most likely placement because the sun shines generally downward. Alternatives are possible, such as solar panels that move to optimal locations to get the most sunlight or mirrors that reflect light onto solar panels that may or may not be upward-facing, but the simplicity of upward-facing solar panels is desirable for many implementations at least because it tends to be cost- and weight-effective. The solar panel(s) may be flat or curved along the contour of the balloon envelope 108, either individually or collectively.

The gondola 112 is intended to represent a device mounted (as illustrated) or tethered to the balloon envelope 108 that includes, internally or externally, electronic components. (In larger blimps, the gondola 112 may or may not carry crew.) The gondola 112 is traditionally attached as a single platform to the bottom of the balloon envelope 108, and there are advantages to doing so, but is not explicitly limited thereto. For example, the gondola 112 could include multiple structures attached at various portions of the hinged blimp system and/or the gondola 112 could be attached to some portion other than under the balloon envelope 108.

In a specific implementation, the gondola 112 includes a battery container, a battery mount, and a battery configured to provide power to a propulsion system and optional payloads, which may include cameras, electronic signs, spotlights, or the like. Depending upon implementation-specific factors, the battery container and the gondola 112 can comprise the same structure, though the battery container may also be implemented as a separate structure inside, outside, or separate from of the gondola 112. In a specific implementation, the battery mount is made of a carbon fiber tube reinforced by Depron® foam, though other suitably sturdy and/or light materials can be used. The battery may be detachable from or fixed to the battery mount. The battery is preferably as light as possible given cost and technological constraints, unless the battery also acts as a ballast. In a specific implementation, the battery includes three sets of re-chargeable lithium polymer (Li—Po) batteries providing 8000 mAh for each; but the type of the battery is not limited thereto. For example, re-chargeable lithium-ion batteries, non-rechargeable lithium batteries, re-chargeable nickel-metal hydride batteries, and non-rechargeable alkaline batteries may be employed. Battery elimination circuitry (BEC) can also be used to centralize power distribution; BEC may harbor a microcontroller unity (MCU).

In an implementation that includes a battery, the power generated using the solar panel(s) 110 can be used to recharge the battery; the solar panel(s) 110 and battery may or may not be considered part of a photovoltaic system. Instead or in addition, power generated using the solar panel(s) 110 can be directly supplied to components for propulsion or other purposes. In a specific implementation, the solar panel(s) 110 enable the battery maintain 95% or more charge after a 90-minute flight of the hinged blimp system.

In an alternative, one or more fins (not shown) may be added to the balloon envelope 108, likely on or near the end of the balloon envelope farthest from the interface section 104. Fins can address weathervaning, which is the tendency of a (non-spherical) balloon to rotate into the wind, making weathervaning quicker and more deliberate, which can improve control. In a specific implementation, the fin is downwardly extending, resulting in a lower center of gravity that improves static stability.

In the example of FIG. 1, the interface section 104 includes a rear transverse strut 114, a medial strut 116, a nose mount 118, rear lateral struts 120, side mounts 122, front lateral struts 124, and a front transverse strut 126. (The front lateral struts 124 and front transverse strut 126 appear to extend into the propulsion module section 106 in the diagram 100A, but are not part of the propulsion module section 106.) These components are intended to represent applicable components used to tether the buoyancy and power module section 102 to the propulsion module section 106. In a specific implementation, the rear transverse strut 114, medial strut 116, rear lateral struts 120, front lateral struts 124, and front transverse strut 126 are stiff members configured to stabilize a supporting position of thrusters (described below) for maneuvering the hinged blimp system. The rear transverse strut 114, the medial strut 116, the rear lateral struts 120, the front lateral struts 124, and the front transverse strut 126 can be made of the same or different materials, such as carbon fiber tubing reinforced with Depron® foam, aluminum, or other suitable materials. The nose mount 118 and the side mounts 122 can be attached to the balloon envelop 108 using an adhesive, such as glue or tape, solder or reflow materials, mechanical joiners, or other suitable materials or devices, and the medial strut 116 and the lateral struts 120 are respectively mated to the nose mount 118 and side mounts 122 in a suitable manner, such as via a clip, socket, adhesive, solder, or the like.

In the example of FIG. 1, the medial strut 116 extends from the rear transverse strut 114 to the balloon envelope 108, where it is attached at a nose mount 118. In a specific implementation, the medial strut 116 is operationally connected to the rear transverse strut 114 using a fastener, such as a bracket, that fixes relative position of the medial strut 116 at or near a midpoint of the rear transverse strut 114. The fasteners can be made from a range of materials, such as aluminum, plastic, or other suitable materials. The rear transverse strut 114 extends along a lower axis that is below and perpendicular to a central axis of the balloon envelope 108 (e.g., a direction approximately parallel to a direction in which the cylindrical shape of the balloon envelope extends). The distance between the lower axis and the central axis can vary somewhat depending upon implementation- and/or configuration-specific factors. The rear transverse strut 114 and rear lateral struts 120 define a plane that is horizontal relative to ground (“the lower horizontal plane”). The angle formed between the medial strut 116 and the lower horizontal plane can vary depending upon implementation- and/or configuration-specific factors, but should fall between no angle (which would put the medial strut 116 in the lower horizontal plane, extending horizontally to the nose mount 118) and a right angle (which would put the medial strut 116 perpendicular to the lower horizontal plane, extending vertically to the nose mount 118). In a specific implementation, the nose mount 118 is attached at an area of the balloon envelope 108 through which the central axis passes, and in most implementations will be as close to center of the front of the balloon envelope 108 as is practical. In an alternative, the rear transverse strut 114 and the medial strut 116 can be replaced with two struts that extend from the rear lateral struts 120 to the nose mount 118 to form a “V” shape.

The rear lateral struts 120 extend from the rear transverse strut 114 to the balloon envelope 108, where it is attached at side mounts 122. In a specific implementation, the rear lateral struts 120 are operationally connected to the rear transverse strut 114 using a fastener, such as a bracket, that fixes relative positions of the rear lateral struts 120 at or near an endpoint of the rear transverse strut 114. As was indicated in the preceding paragraph, the rear transverse strut 114 and rear lateral struts 120 define the lower horizontal plane. In a specific implementation, the side mounts 122 are located aft of the start of the cylindrical (untapered) portion of the balloon envelope 108. A dotted line 150 has been added to the diagram 100A to illustrate the intersection between the hemispherical “nose portion” of the balloon envelope 108 and the cylindrical “central portion” of the balloon envelope 108. In general, the closer the rear lateral struts 120 are to one another, the closer to the bottom of the balloon envelope 108 they will be, and the farther the rear lateral struts 120 are from one another, the closer the rear lateral struts 120 are to defining a central horizontal plane with the central axis of the balloon envelope 108. Both of these extremes have been determined to be suboptimal in specific implementations. A suitable configuration places the side mounts 122 between π/8 and π/4 radians, inclusive, measured from the bottom of the central (cylindrical) portion of the balloon envelope 108.

The front lateral struts 124 extend from the rear transverse strut 114 away from the balloon envelope 108 to the front transverse strut 126. In a specific implementation, the front lateral struts 124 are operationally connected to the front transverse strut 126 using a fastener, such as a bracket, that fixes relative positions of the front lateral struts 124 at or near an endpoint of the front transverse strut 126. The diagram 100B at least conceptually illustrates how the front lateral struts 124 and the rear lateral struts 120 could be implemented as a pair of lateral struts. Specifically, a first of the front laterals struts 124 and a first of the rear lateral struts 120 could be implemented as a continuous first lateral strut and a second of the front laterals struts 124 and a second of the rear lateral struts 120 could be implemented as a continuous second lateral strut.

In various implementations, payloads are attached at the interface section 104, though payloads, or components thereof, can be attached at other locations of a hinged blimp system. For example, a photogrammetry payload, which may include a camera mount and camera, can be attached to one or more of the struts. A surveillance system can capture still and/or video images in 2D and/or 3D formats. The camera can have an internal battery that is dedicated to supply power to the camera, or power can be provided to the camera via a photovoltaic system or battery, as described previously. The camera may be capable of wireless communication in accordance with, radio waves, including cellular, WiFi, Bluetooth, or the like, such that the camera can interact with components in the hinged blimp system or an external device, such as a controlling device located on the ground while the hinged blimp system is deployed. In a specific implementation, the camera may include an optical and/or electronic image stabilizing module to stabilize images captured by the camera, in particular, in windy or gusty conditions, and a wind noise reduction module to reduce noise included audio data obtained from an internal microphone. In a specific implementation, the camera may also include a location system (e.g., GPS sensor) to locate a position of the camera and associate the captured image (and audio data) with the location sensed by the location system. In a specific implementation, the surveillance system can make use of a commercially-available product, such as cameras designed, fabricated, and sold by GoPro Inc.

In the example of FIG. 1, the propulsion module section 106 includes a vectored thrust frame 128, thruster units 130, and a thrust vector joint 132. The vectored thruster frame 128 is intended to represent a stiff member configured to support the thruster units 130 mounted thereon. In a specific implementation, the vectored thrust frame 128 is made from a carbon fiber tube reinforced by Depron® foam, but can be made from other suitable materials. The diagram 100C illustrates a connected double-plus configuration for the vectored thrust frame 128. The diagram 200 illustrates alternative configurations, including a one dimensional side-by-side configuration 202, a one-dimensional front-to-back configuration 204, a T-configuration 206, a Y-configuration 208, an H-configuration 210, and an X-configuration 212.

In the example of FIG. 1, the thruster units 130 are attached at six tip ends of the vectored thrust frame 128. The thruster units 130 include one or more propellers coupled to a motor (e.g., a brushless electric motor) to rotate the propellers. In a specific implementation, the thruster units 130 include a two-bladed 9-inch propeller formed of carbon fiber, but other shapes, sizes, and materials can be used in alternative implementations. A first thruster unit of the thruster units 130, labeled ‘1’ in the diagram 100C (and visible as the front-most thruster unit 130 in the diagram 100A), rotates in a counter-clockwise direction. A second thruster unit of the thruster units 130, labeled ‘2’ in the diagram 100C (and visible as the rear-most thruster unit 130 in the diagram 100A), rotates in a clockwise direction. A third thruster unit of the thruster units 130, labeled ‘3’ in the diagram 100C (and partially blocking the second thruster unit in the diagram 100A), rotates in a counter-clockwise direction. A fourth thruster unit of the thruster units 130, labeled ‘4’ in the diagram 100C (not visible in the diagram 100A), rotates in a clockwise direction. A fifth thruster unit of the thruster units 130, labeled ‘5’ in the diagram 100C (partially blocking the first thruster unit and completely blocking the fourth thruster unit in the diagram 100A), rotates in a clockwise direction. A sixth thruster unit of the thruster units 130, labeled ‘6’ in the diagram 100C (not visible in the diagram 100A), rotates in a counter-clockwise direction. Alternatives with even numbers of thruster units are expected to have half of the thruster unit propellers rotating in a first (e.g., clockwise) direction and half of the thruster unit propellers rotating in a second (e.g., counter-clockwise) direction as they do in the example of FIG. 1.

In the example of FIG. 1, the thrust vector joint 132 is located at a pivot point intersecting the dashed line 160 illustrated in diagram 100C. (In a specific implementation, the dashed line 160 is parallel to and in the same vertical plane as the front transverse strut 126.) The thrust vector joint 132 is intended to represent a device configured to allow the vectored thrust frame 128 to pitch and roll. Advantageously, use of the thrust vector joint 132 allows the vectored thrust frame 128 to pitch and roll, which makes the hinged blimp system easier to control, even for pilots with limited experience. It may be noted, arrangements involving only one or two thruster units 130 may require a gimbal or servo control at the thrust vector joint 132. As is illustrated in diagram 100D, the thrust vector joint 132 includes a joint frame 134, a pitch hinge 136, and a roll hinge 138.

The pitch hinge 136 is rotatably connected to the front transverse strut 126 such that when the front transverse strut 126 rotates (which is associated with changes in pitch), the pitch hinge 136 allows at least some of the rotation. In a specific implementation, the pitch hinge 136 includes a pair of ball bearings mounted on opposing sides of the joint frame 134, with the front transverse strut 126 passing through a hole in the joint frame 134 like an axel that is operationally connected to the ball bearings. Depending upon implementation- and/or configuration-specific factors, the pitch hinge 136 may arrest rotation at some point. For example, the pitch hinge 136 may allow a ±45° change in pitch, but not allow for more.

The roll hinge 138 is rotatably connected to the vectored thrust frame 128 such that when the vectored thrust frame 128 rotates (which is associated with changes in roll), the roll hinge 138 allows at least some of the rotation. In a specific implementation, the roll hinge 138 includes a pair of ball bearings mounted on opposing sides of the joint frame 134, with the vectored thrust frame 128 passing through a hole in the joint frame 134 like an axel that is operationally connected to the ball bearings. Depending upon implementation- and/or configuration-specific factors, the roll hinge 138 may arrest rotation at some point. For example, the roll hinge 138 may allow a ±45° change in roll, but not allow for more.

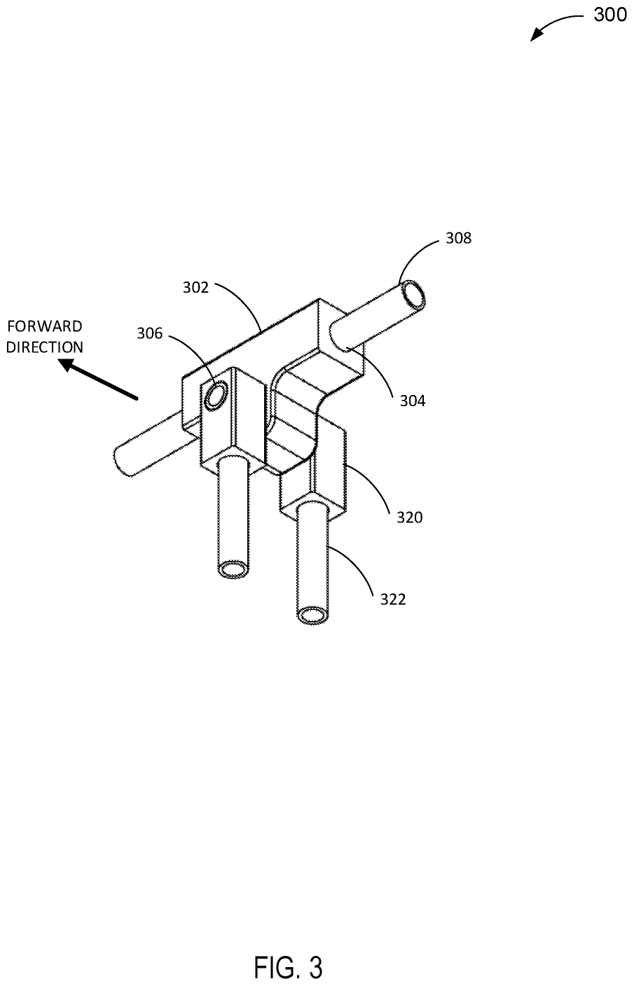

FIG. 3 is a diagram 300 of a perspective view of an alternative thrust vector joint of a hinged blimp system. The diagram 300 includes a joint frame 302, a pitch hinge 304, and a roll hinge 306. A front transverse strut 308 passes through a hole associated with the pitch hinge 304. Roll-enabled sockets 320 receive tethering struts 322 that are connected to a thruster frame (not shown), thereby tethering the thruster frame to the roll-enabled sockets 320. The tethering struts 322 extend downward to the thruster frame, which is below the roll-enabled sockets 320, but in an alternative the thruster frame could be above.

Referring once again to FIG. 1, in a specific implementation, a control box may be located in the gondola 112 or elsewhere on the hinged blimp system. The control box may include a controller for the vectored thrust frame 128 or components attached thereto, in particular, a motor coupled to the thruster units 130. In an alternative, the control box is attached to the vectored thruster frame 128. A more specific configuration of the control box is described later.

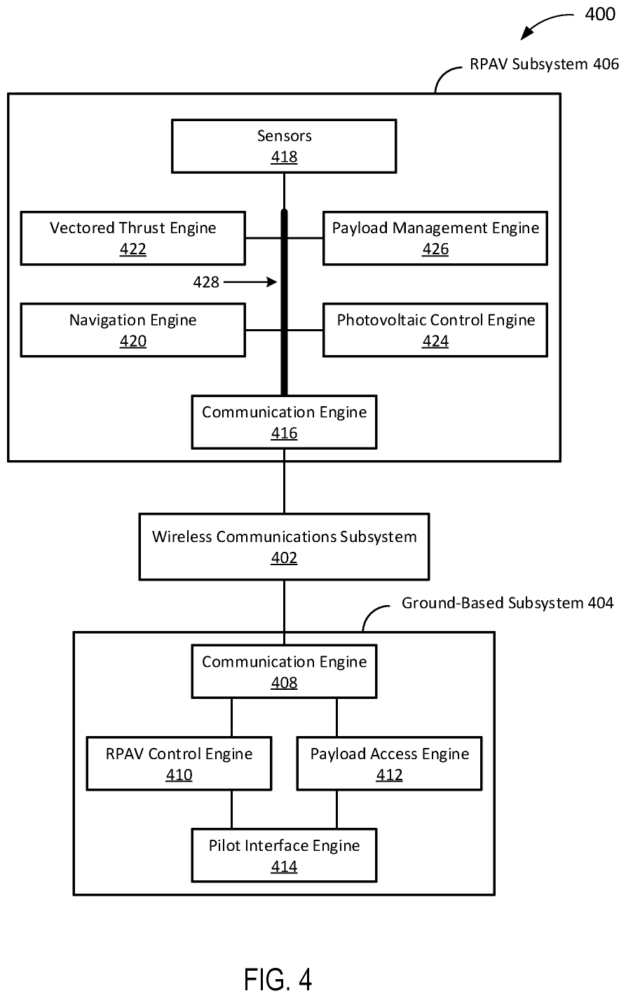

FIG. 4 depicts a diagram 400 of an example of a remotely piloted airship system (RPAS). The diagram 400 includes a wireless communications subsystem 402, a ground-based subsystem 404, and a remotely piloted airship vehicle (RPAV) subsystem 406. The term unmanned aircraft system (UAS) was adopted by the United States Department of Defense (DoD) and the United States Federal Aviation Administration in 2005 according to their Unmanned Aircraft System Roadmap 2005-2030 and the International Civil Aviation Organization (ICAO) and the British Civil Aviation Authority adopted this term, also used in the European Union's Single-European-Sky (SES) Air-Traffic-Management (ATM) Research (SESAR Joint Undertaking) roadmap for 2020. The term UAS emphasizes the importance of elements other than the aircraft and includes elements such as ground control stations, data links and other support equipment. RPAS is a similar term that is typically an acronym of “remotely piloted aerial system,” but as used in this paper, the RPAS is assumed to represent the components of a hinged blimp system (see, e.g., FIG. 1). A UAV is defined as a “powered, aerial vehicle that does not carry a human operator, uses aerodynamic forces to provide vehicle lift, can fly autonomously or be piloted remotely, can be expendable or recoverable, and can carry a lethal or nonlethal payload.” RPAV is a similar term that is typically an acronym of “remotely piloted aerial vehicle,” but as used in this paper, the RPAV is assumed to represent the components attached to the vehicle (e.g., the hinged blimp).

In the example of FIG. 4, the wireless communication subsystem 402 is intended to represent a wireless medium traversable by electromagnetic, acoustic, or other signals and applicable hardware nodes, such as repeaters, cell towers, satellites, or the like. In a minimalist implementation, the wireless communication subsystem 402 includes no hardware, and simply acts as a medium for carrying wireless signals from the ground based system 404 to the RPAV subsystem 406, but in various implementation the wireless communication subsystem 402 also includes, for example, GPS satellites, repeaters, cell towers, or the like. In general, wireless communication can be defined as the transfer of information or power between two or more points that are not connected by an electrical conductor. The most common wireless technologies use radio waves.

In the example of FIG. 4, the ground-based subsystem 404 includes a communication engine 408, an RPAV control engine 410, and a payload access engine 412. In a specific implementation, the communication subsystem 408 is a radio communication subsystem that includes a transmitter and/or receiver (collectively, e.g., a transceiver), an antenna array of one or more antennas, and appropriate terminal equipment (including, e.g., input, output, or i/o devices).

In the example of FIG. 4, the RPAV control engine 410 is intended to represent the hardware (e.g., processor, memory, etc.) specifically purposed (often via software) to enable helm, navigation, and/or engineering control of the RPAV. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a CRM for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Memory associated with the RPAV control engine 410 can be characterized as a datastore. As used in this paper, datastores are intended to include repositories having any applicable organization of data, including computer instructions, tables, comma-separated values (CSV) files, traditional databases (e.g., SQL), or other applicable known or convenient organizational formats. Datastores can be implemented, for example, as software embodied in a physical computer-readable medium (CRM) on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

In a specific implementation, the RPAV can receive instructions via a source other than the RPAV control engine 410, such as from a cloud platform. The RPAV can also be configured with instructions generally or in advance of deployment, either via the RPAV control engine 410 or some other source.

The payload access engine 412 is intended to represent hardware specifically purposed to create, update, or delete instructions associated with a payload installed on the RPAV, which are transmitted to the RPAV via the communication engine 408. Instructions can also be provided via some other source than the payload access engine 412. In a specific implementation, the payload access engine 412 includes a payload-related datastore that can be accessed as signals are received via the communication engine 408. Alternatively or in addition, the payload-related datastore can be implemented elsewhere, such as in the cloud and may or may not be accessible via the ground-based subsystem 404. As used in this paper, “access” is intended to mean one or more of creation, reading, updating, or deleting data in a datastore.

The pilot interface engine 414 is intended to represent hardware specifically purposed to receive input from a human or artificial agent at the ground-based subsystem 404 and to provide output for the human or an artificial agent at the ground-based subsystem 404. Input devices can be implemented as a joystick or other dedicated devices, via a touchscreen, or through some other applicable user interface. Depending upon implementation- and/or configuration-specific factors, the pilot interface engine 414 may also provide output to the human or artificial agent. Output devices can be implemented as LEDs or other dedicated devices, via a display, or through some other applicable user interface. In a specific implementation, the pilot interface engine 414 is also used to provide input from the human or an artificial agent to the payload access engine 412. Instead or in addition, the pilot interface engine 414 can provide output to the human or an artificial agent from the payload access engine 412.

In the example of FIG. 4, the RPAV subsystem 406 includes a communication engine 416, sensors 418, a navigation engine 420, a vectored thrust engine 422, a photovoltaic subsystem control engine 424, and a payload management engine 426. The various components are coupled together via a communications plane 428, which can be implemented using an applicable technology. In a specific implementation, the communication subsystem 416 is a radio communication subsystem that includes a transmitter and/or receiver (collectively, e.g., a transceiver), an antenna array of one or more antennas, and appropriate terminal equipment (including, e.g., input, output, or i/o devices).

The sensors 418 are intended to represent at least hardware associated with enabling the RPAV to react to environmental stimuli, such as altitude, windspeed, humidity, visibility, or the like. In a specific implementation, the sensors 418 includes an inertial measurement unit (IMU), which, for example, includes 3-axis accelerometers, 3-axis gyroscopic sensors, and 3-axis magnetometers to detect specific force, angular rate, and magnetic field near the RPAV. Gyroscopic sensors, for example, may employ a variety of measurement types, including mechanical, laser, and fiber-optic. The sensors 418 could be characterized as including a global positioning system (GPS) sensor to locate a geographic position of the RPAV and/or improve accuracy of measurement by the IMU, but in this paper GPS signals are generally treated as being received through the communication engine 416 and used by the navigation engine 420.

The navigation engine 420 is intended to represent at least hardware associated with implementing, updating, and deleting a flight plan for the RPAV. Depending upon implementation- and/or configuration-specific factors, navigation can be updated in response to sensor data from the sensors 418 or GPS data or remote pilot commands from the communication engine 416. In a specific implementation, the navigation engine includes autopilot software for, e.g., a hexacopter-type airframe. Autopilot software can be implemented with proprietary software or by modifying available autopilot software. For example, Pixhawk 2 is an open-source flight controller distributed by multiple vendors and designed, fabricated, and sold by DJI Co., Ltd.

The navigation engine 420 is configured to receive commands such as a takeoff command to start a flight, data such as waypoints (geographical locations) of a flight path, a land command, and the like from the communication engine 416, and to generate commands for the vectored thrust engine 422 to cause the vectored thrust engine 422 to maneuver in a manner conducive to following the desired flight path. During flight the navigation engine 420 controls speed, altitude, direction, and so on by providing instructions to the vectored thrust engine 422 to control motors of thruster units in an appropriate manner, such as by setting a rotational speed of propellers of the thruster units.

The vectored thrust engine 422 is intended to represent at least hardware associated with controlling the orientation of a vectored thrust frame. Although the vectored thrust engine 422 can include drivers for thrust unit motors, the degree of control over thrust units can vary depending upon implementation- and/or configuration-specific factors. For example, the vectored thrust engine 422 may or may not have granular control over individual thruster units, control over direction of propeller rotation, control over the amount of power directed to thruster units, and the like. Advantageously, a thrust vector joint can simplify vectored thrust control, parameters of which are incorporated into the vectored thrust engine 422. For example, the vectored thrust engine 422 can be limited to n/4 radians of pitch due to known thrust vector joint operational parameters. In a specific implementation, the vectored thrust engine 422 includes computer stabilization functionality that uses input from, e.g., the sensors 418 to control the pitch and roll of a vectored thrust frame.

It may be noted, in some implementations the navigation engine 420 and the vectored thrust engine 422 appear to be a single engine because software blurs the line between navigation and flight control.

The photovoltaic control engine 424 is intended to represent at least hardware associated with a photovoltaic system. The complexity of photovoltaic system control can vary depending upon implementation- and/or configuration-specific factors.

The payload management engine 426 is intended to represent at least hardware associated with a payload carried by the RPAV. For example, the payload management engine 426 may enable control of a camera, camera mount actuator, and photographic datastore for a photogrammetry payload; signage for an advertising payload; or spotlights for an entertainment venue payload, to name a few. It may be noted that cameras can instead or in addition be implemented as one or more of the sensors 418 and used for improved navigation and/or flight control.

In an example of operation, a system such as is illustrated in FIG. 4 operates as follows. The ground-based subsystem 404 transmits, through the wireless communication subsystem 402, commands and/or flight or payload-related data to the RPAV subsystem 406. Specifically, the communication engine 408 transmits commands and/or flight or payload-related data received from the RPAV control engine 410 and/or the payload access engine 412. The RPAV control engine 410 and the payload access engine 412 are controlled by a human or artificial agent providing input via the pilot interface engine 414. The commands and/or flight or payload-related data are received by the communication engine 416 and used by the sensors 418, navigation engine 420, vectored thrust engine 422, photovoltaic control engine 424 and/or payload management engine 426. Signals and data can also be sent in the opposite direction or from the communication engine 416 to some other location, such as cloud storage accessible via a cellular path (not shown). The order of operation is typically 1) pre-deployment configuration (e.g., flight plan and payload configuration), 2) takeoff command (which may be part of the pre-deployment flight plan configuration), 3) in-flight status and payload-related data transmissions, 4) landing command (which may be part of the pre-deployment flight plan configuration), and 5) post-deployment data dump.

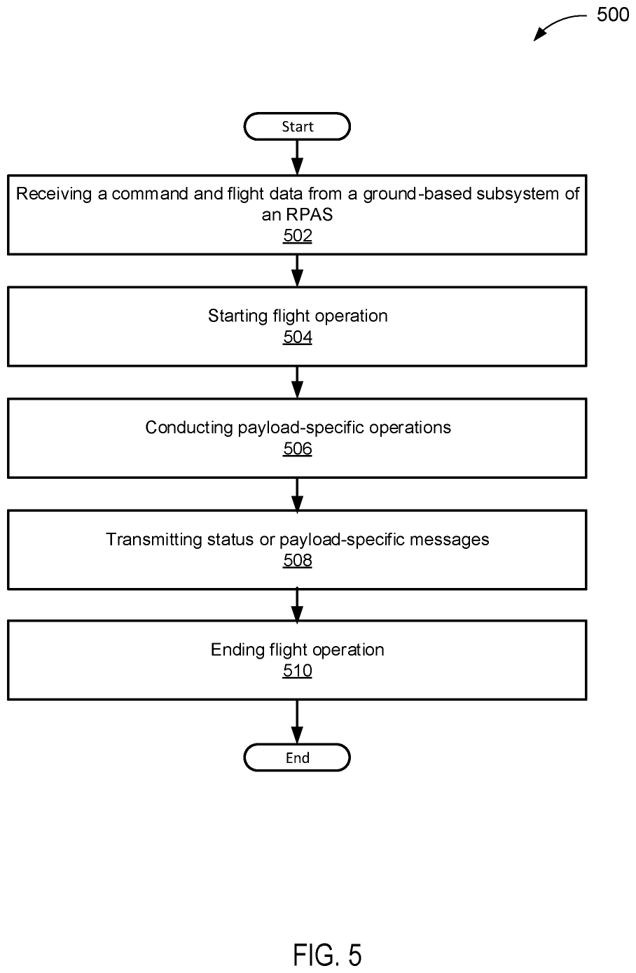

FIG. 5 depicts a flowchart 500 of an example of a method for carrying out a flight operation of a hinged blimp system. This flowchart organized in a fashion that is conducive to understanding. It should be recognized, however, that the modules can be reorganized for parallel execution, reordered, modified (changed, removed, or augmented), where circumstances permit. The flowchart 500 starts at module 502, with receiving a command and flight data from a ground-based subsystem of an RPAS. In a specific implementation, the flight data may be received in advance prior to receiving the command (e.g., to enable pre-flight configuration) or received along with the command.

In the example of FIG. 5, the flowchart 500 continues to module 504 with starting a flight operation. Starting flight operation can entail executing auto-flight software in accordance with flight data. In a specific implementation, motor(s) coupled to propellers of a thruster unit of the RPAV start rotating to cause the hinged blimp to ascend in the air, and then are controlled to cause the hinged blimp system to fly to waypoints based on the flight data.

In the example of FIG. 5, the flowchart 500 continues to module 506 with conducting payload-specific operations. For example, a photogrammetry payload may entail initiating image capture, by controlling a camera and/or a camera mount actuator mounted to a hinged blimp.

In the example of FIG. 5, the flowchart 500 continues to module 508 with transmitting status or payload-specific messages. Status messages can provide useful data to a remote pilot regarding such things as battery life, estimated time of arrival, or the like. Payload-specific messages can include image data for a photogrammetry payload to a photogrammetry datastore.

In the example of FIG. 5, the flowchart 500 ends at module 510 with ending flight operation. Flight operation typically ends when the RPAV lands.

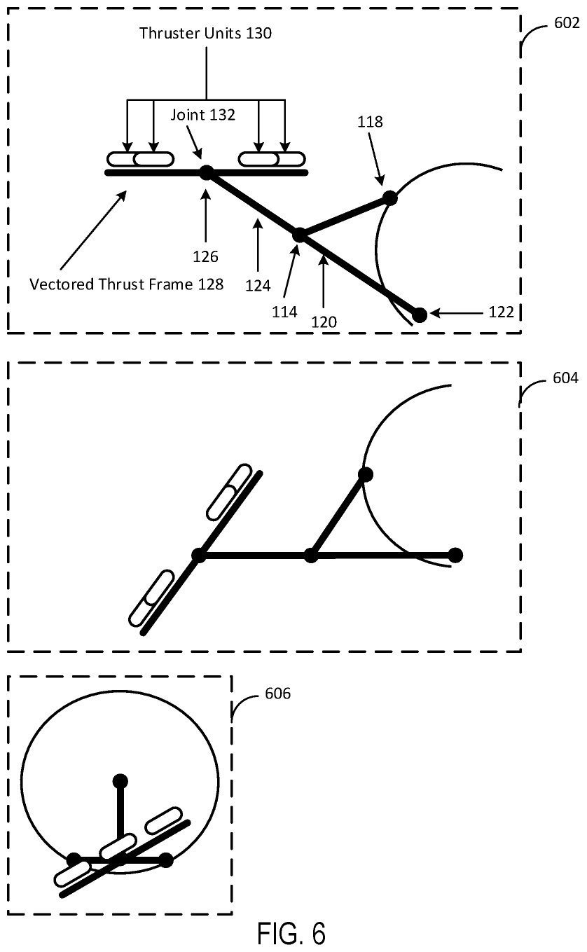

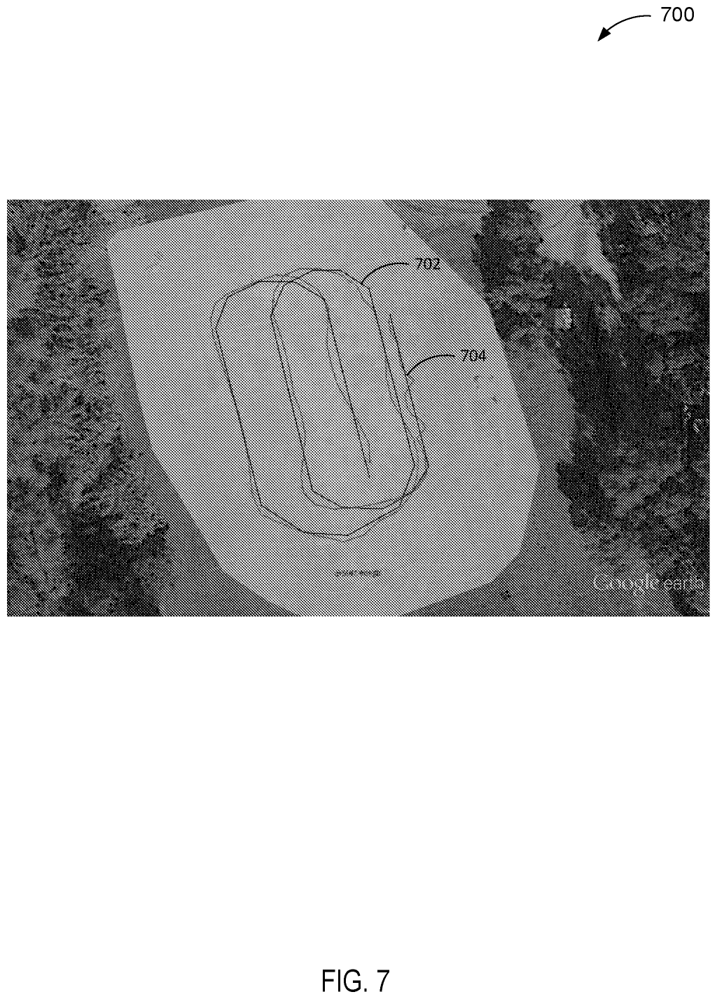

FIG. 6 illustrates configurations of the propulsion module section of the hinged blimp system of FIG. 1A in operation. FIG. 6 is intended to illustrate how a vector thrust joint enables a hinged blimp to take off (602), move forward (604), and turn (606). In the state shown in FIG. 1A, the rear lateral struts 120, the front lateral struts 124, and the vectored thrust frame 128 define the lower horizontal plane, which is approximately parallel to ground, with the thruster units 130 facing upward. A takeoff configuration has the thruster units 130 facing upwards.

As the thruster units 130 lift off the ground, the vectored thrust frame 128 maintains itself level to the ground through computer stabilization. As the vectored thrust frame 128 climbs, the rear of the balloon envelope 108 rests on the ground and the hinged blimp pitches up. As the hinged blimp lifts off the ground or dock (602), the vectored thrust frame 128 remains approximately parallel to ground, but the rear lateral struts 120 and front lateral struts 124 are allowed by the thrust vector joint 132 to angle downward away from the vectored thrust frame 128. The balloon envelop 108 is pitched up due to its attachment to the nose mount 118 and side mounts 122 attaching the balloon envelope 108 to the struts. The thrust vector joint 132 may limit changes in pitch by restricting rotation of the front lateral struts 124 around the front transverse strut 126 to π/4 radians or so. This may be referred to as having a pitch hinge of the thrust vector joint 132 bottom out. The pitch hinge bottoming out may be associated with hinged blimp lift-off and/or a maximum altitude increase rate range. It is possible to reach the maximum altitude increase rate range threshold when the pitch hinge bottoms out, but to exceed the threshold further by, e.g., increasing power to the thruster units 130; the maximum altitude increase rate range threshold to the maximum altitude increase power rate can be referred to as the maximum altitude increase rate range. (Actual maximum altitude increase rate can vary depending upon environmental factors.) When at a desired altitude, a vectored thrust engine can control the thruster units 130 to reduce propeller rotational speed and cause the hinged blimp to hover, resembling the state illustrated in FIG. 1A, or transition to forward flight.

A shift from the thrust units 130 to the balloon envelope 108 as the primary lift-creation mechanism can be referred to as a “forward flight transition.” For the hinged blimp to transition to forward flight, power to aft thrusters of the thruster units 130 is increased relative to the forward thrusters of the thruster units 130. This creates a pitching moment about the pitch hinge of the thrust vector joint 132 causing the vectored thrust frame 128 to tilt forward (604). When the vectored thrust frame 128 is tilted forward, the thruster units 130 act primarily to create forward thrust for the hinged blimp, which is associated with horizontal velocity. Propeller rotational speed can vary depending on an algorithm designed to control the thruster units 130 to cause the vectored thruster frame 128 to pitch forward. For example, propellers of one or more aft thruster units of the thruster units 130 may be controlled to have greater rotational speed than one or more forward thruster units of the thruster units 130. The thrust vector joint 132 may limit changes in pitch by restricting rotation of the vectored thruster frame 128 around the front transverse strut 126 to π/4 radians or so.

In the example of FIG. 6, in the forward vector state (604), the rear lateral struts 120, the front lateral struts 124, and the vectored thrust frame 128 define the lower horizontal plane, which is approximately parallel to ground, with the thruster units 130 tilted forward. In a specific implementation, the balloon envelope 108 is shaped like an airfoil, so at high angle of attack, substantial lift can be generated. At higher speeds, the angle of attack of the balloon envelope 108 decreases and so too does the resultant lift, but increasing speed also causes an increase in lift. If the rate of change of angle of attack is proportional to the rate of change of speed, lift can be maintained at or near constant throughout the acceleration of the hinged blimp.

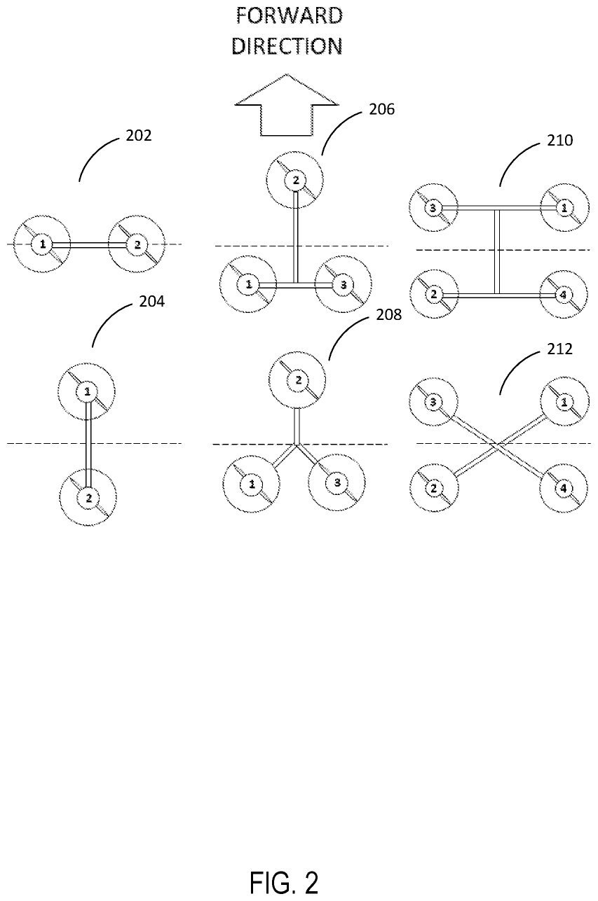

In the example of FIG. 6, in a turning state (606), the thrust vector joint 132 allows the vectored thruster frame 128 to roll. In the example of FIG. 6, the turning state (606) is associated with a starboard (right) turn, though this is obviously for illustrative purposes; the process for a port (left) turn is analogous. For a starboard turn, port thrusters of the thruster units 130 (e.g., those on the port side of a roll hinge of the thrust vector joint 132) on the vectored thrust frame 128 increase their thrust relative to starboard thrusters of the thruster units 130 (e.g., those on the starboard side of the roll hinge). This causes the vectored thrust frame 128 to roll right over the roll hinge and maintain a roll angle relative to the hinged blimp. In a specific implementation, the vectored thrust frame 128 has openings in a band (a “clearance band”) that extends fore and aft of the diagonal line 160 (see FIG. 1C) to allow the starboard thrusters or the port thrusters to dip below the front transverse strut 126. In an alternative for which there are no fore and aft thrusters (see, e.g., FIG. 2, 202), an offset strut may be used to move the vectored thrust frame 128 vertically and/or horizontally relative to the front transverse strut 126 to enable the starboard and port thrusters to roll without interference from the front transverse strut 126. The horizontal component of thrust now acts as a starboard turning force, causing the hinged blimp to turn to starboard while in forward flight, or yaw to starboard in a hover.

Advantageously, according to the above configuration of the hinged blimp system, it is possible to cause the hinged blimp to fly passing accurately predetermined positions under various wind and gust conditions, relative to a comparative configuration of a hinged blimp system. FIG. 8 depicts an experimental result 800 obtained by flight of a prototype hinged blimp incorporating techniques described in this paper. The experimental result 800 depicted in FIG. 8 was obtained by setting about 30 predetermined locations within a soccer field-sized geographic region, and controlling the prototype hinged blimp to traverse waypoints. In FIG. 8, an ideal path 802 illustrates a shortest distance path through the waypoints, and an actual path 804 indicates a path taken by the prototype hinged blimp to traverse the waypoints. As can be seen in FIG. 8, the prototype hinged blimp traversed the waypoints along the actual path 804 with minor deviation from the ideal path 802.

FIGS. 8A, 8B, and 8C illustrate views of a hinged blimp with alternative structures. FIG. 8A illustrates an oblique view 800A that includes a clear blimp 802, internal solar panels 804, a vector thrust unit (VTU) support structure 806, and a VTU 808. The clear blimp 802 is clear to allow sunlight to pass through the blimp to the internal solar panels 804, which are upward-facing. In the relevant context, clear is intended to mean sufficient to allow sunlight to pass through a balloon envelope; as such, clear could mean transparent or translucent. The VTU support structure 806 has a unique organization of component members, but is used to support the VTU 808 much as was described previously (see, e.g., discussion of components 114-132 of FIG. 1, above).

FIG. 8B illustrates a side view 800B, including a side view, full forward flight 810 and a side view, hover flight 812. As was described previously, the VTU frame tilts in the direction of vertical (though one, some, or all of the VTUs may or may not actually reach fully vertical relative to ground) when in forward flight and the VTU frame tilts in the direction of horizontal (though one, some, or all of the VTUs may or may not actually reach fully horizontal relative to ground) in hover mode.

FIG. 8C illustrates a front view 800C in right turn, hover, and left turn configurations.

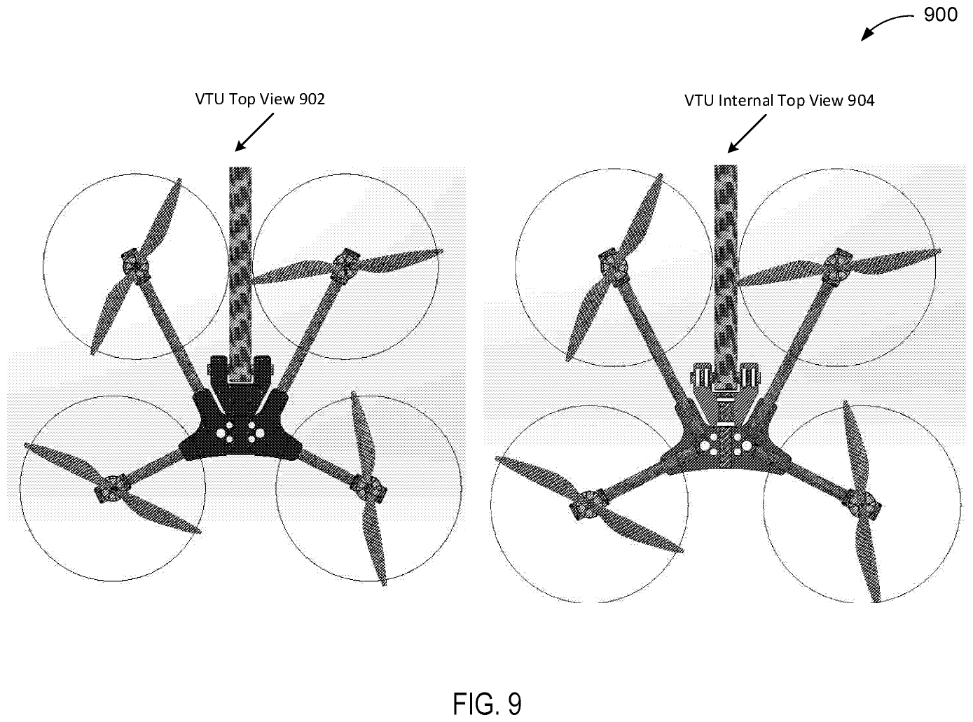

FIG. 9. Illustrates views 900 of a VTU top view 902 and VTU internal top view 904.

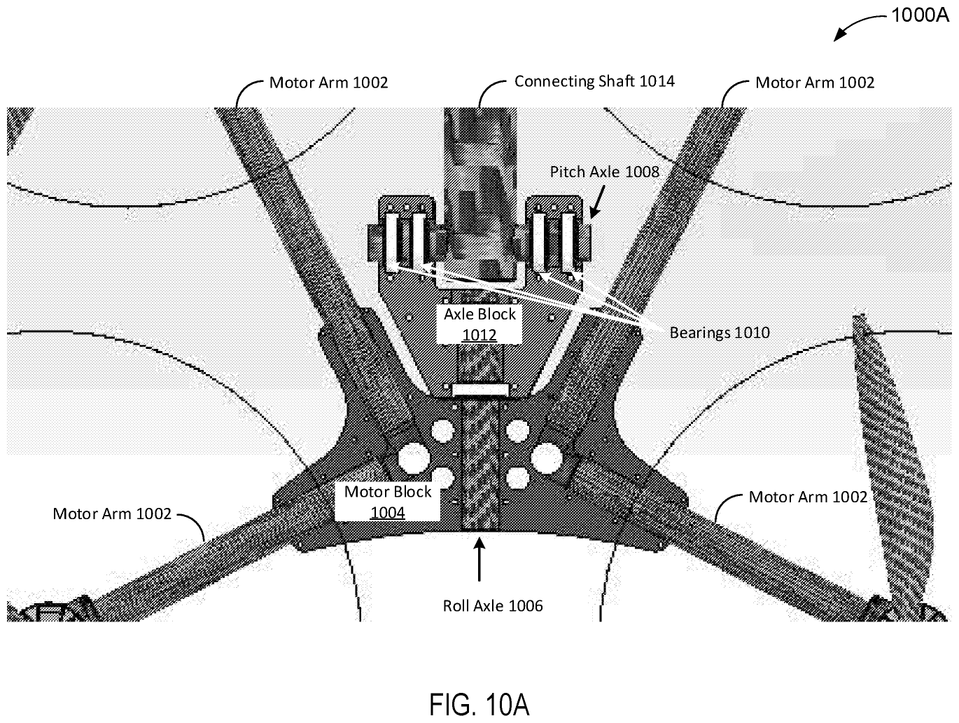

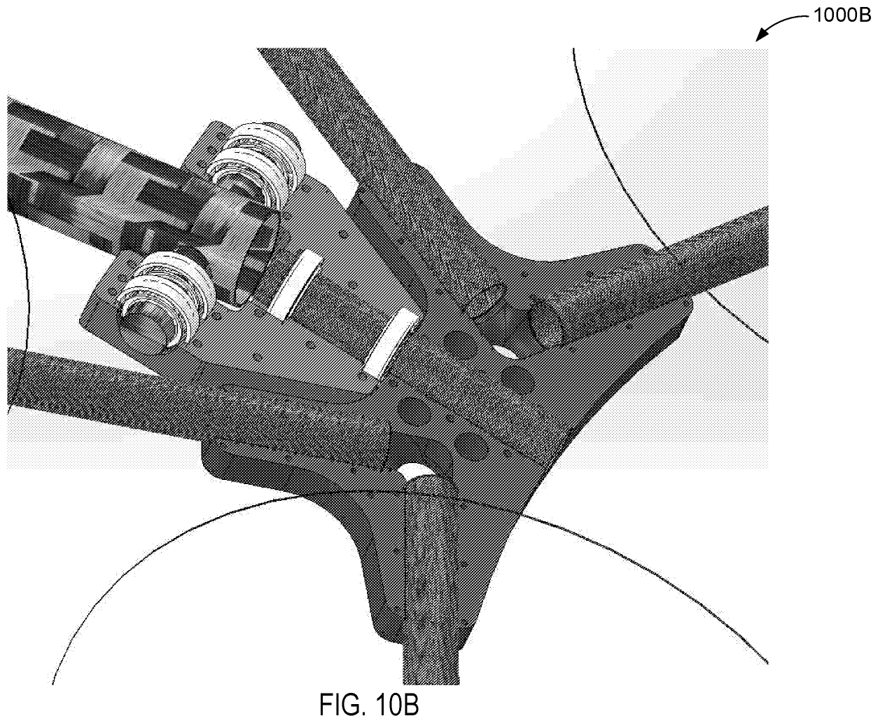

FIGS. 10A and 10B illustrate different views of the top internal view of a VTU structure. FIG. 10A illustrates a close up VTU internal top view 1000A. The internal top view includes motor arms 1002 that extend from a motor block 1004 to individual VTUs (not labeled, but partially illustrated). In a specific implementation, the motor is rigidly clamped to a roll axle 1006. The roll axle is operationally coupled to a pitch axle 1008 via bearings 1010 in an axle block 1012. The axle block is operationally connected to an aircraft via a single connecting shaft 1014. Note that, in FIG. 10, the reference arrows for the bearings 1010 are white (instead of black) to improve visibility.

FIG. 10B illustrates an oblique close up VTU internal top view 1000B.

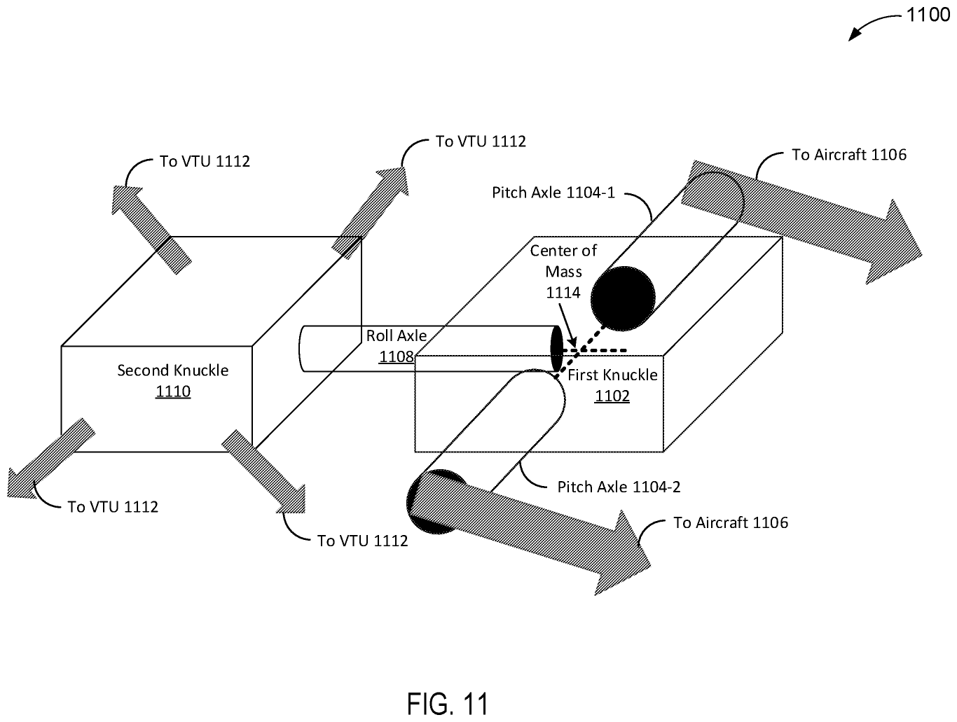

FIG. 11 depicts a conceptual diagram of a centrally mounted VTU structure in a T configuration where one of a pitch axle and a roll axle is terminated at the intersection of the pitch and roll axles. In a specific implementation, this breaks a single knuckle, as is depicted by way of example in FIGS. 1-3, into two semiknuckles. The diagram 1100 includes a first knuckle 1102 (which can also be referred to as a semiknuckle), pitch axles 1104-1 and 1104-2 (collectively, the bifurcated pitch axle 1104) rotatably coupled to the first knuckle 1102, “to aircraft” arrows 1106 indicative of structure operationally coupling the bifurcated pitch axle 1104 to an aircraft (not shown, but examples provided previously), a roll axle 1108 rotatably coupled to the first knuckle 1102, a second knuckle 1110 rotatably coupled to the roll axle 1108, and “to VTU” arrows 1112 indicative of structure operationally coupling the second knuckle to VTUs (not shown, but examples provided previously). In a specific implementation, center of mass is near the center of mass indicator 1114 in operation. In an alternative, the bifurcated pitch axle is replaced with a monolithic pitch axle.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

1. A machine comprising:
a buoyancy and power module, wherein the buoyancy and power module includes a balloon envelope;
an interface module operationally connected to the buoyancy and power module, wherein the interface module includes a strut that is operationally connected to the balloon envelope;
a propulsion module operationally connected to the interface module, wherein the propulsion module includes a vectored thrust frame that is configured to enable pitch and roll of thruster units operationally connected to the vectored thrust frame via a joint coupling the vectored thrust frame to the interface module.

2. The machine of claim 1 comprising:
solar panels operationally coupled to the balloon envelope;
a battery in which power obtained via the solar panels is stored;
wherein, in operation, the battery acts as a power source for the thruster units.

3. The machine of claim 2, wherein the balloon envelope is clear and the solar panels are inside the balloon envelope.

4. The machine of claim 1 comprising a gondola operationally coupled to the balloon envelope.

5. The machine of claim 1 comprising a fin operationally coupled to the balloon envelope.

6. The machine of claim 1, wherein the strut is a medial strut connected to the balloon envelope via a nose mount.

7. The machine of claim 6, wherein the nose mount is a first balloon mount, comprising a rear strut connected to the balloon envelope via a second balloon mount, wherein the first balloon mount and the second balloon mount are two of only two mounts coupling the balloon envelope to the vectored thrust frame.

8. The machine of claim 1, wherein the strut is connected to the balloon envelope via a balloon mount.

9. The machine of claim 8 comprising a medial strut connected to the balloon envelope via a nose mount.

10. The machine of claim 8, wherein the balloon mount is a first side mount and wherein the strut is a first rear lateral strut connected to the balloon envelope via the first side mount, further comprising a second rear lateral strut connected to the balloon envelope via a second side mount.

11. The machine of claim 1 comprising:
a rear lateral strut operationally connected to the balloon envelope;
a front lateral strut operationally connected to the vectored thrust frame;
wherein the rear lateral strut is operationally connected to the front lateral strut via a rear transverse strut.

12. The machine of claim 1 comprising a front lateral strut operationally connected to the vectored thrust frame via a joint, wherein the joint comprises a knuckle having an associated pitch axle and roll axle.

13. The machine of claim 12, wherein at least one of the pitch axle and the roll axle is bifurcated at the knuckle.

14. The machine of claim 1 comprising a front lateral strut operationally connected to the vectored thrust frame via a joint, a pitch axle rigidly operationally connected to the strut, and a roll axle, wherein the joint comprises a first knuckle rotatably connected to the pitch axle and the roll axle and a second knuckle rotatably connected to the roll axle and rigidly operationally connected to the vectored thrust frame.

15. A system comprising:
a hinged blimp including a hinge and a blimp;
a remotely piloted airship vehicle (RPAV) subsystem including a vectored thrust engine with a vectored thrust frame operationally connected to the hinge, wherein the vectored thrust engine is for controlling pitch and roll of the vectored thrust frame by providing control instructions to a plurality of vectored thrust units rigidly operationally connected to the vectored thrust frame;
wherein the blimp is moved in accordance with activation of the vectored thrust units.

16. The system of claim 15 comprising a ground-based subsystem, wirelessly connected to the RPAV subsystem, the ground-based subsystem including a pilot interface engine for receiving piloting input that is, in operation, provided to the RPAV subsystem via a wireless communications subsystem.

17. The system of claim 15, wherein the RPAV subsystem further includes a navigation engine for implementing, updating, and deleting a flight plan for the hinged blimp.

18. The system of claim 15, wherein the RPAV subsystem further includes a navigation engine configured to receive waypoints of a flight path and to generate commands for the vectored thrust engine to cause the vectored thrust engine to maneuver in a manner conducive to following the flight path.

19. The system of claim 15, wherein the RPAV subsystem further includes a payload management engine.

20. The system of claim 15, wherein the RPAV subsystem further includes a photovoltaic control engine.
